(19) United States
(12) Patent Application Publication
(10) Pub. No.: US 2019/0090477 A1
(43) Pub. Date: Mar. 28, 2019

(54) WATER CONDITIONING AND DRIFT CONTROL COMPOSITIONS AND METHODS OF USE

(71) Applicant: RHODIA OPERATIONS, Paris (FR)

(72) Inventors: Hong LIU, Pennington, NJ (US); Chunhui BAO, Bensalem, PA (US); Subramanian KESAVAN, East Windsor, NJ (US); Charles MANZI-NSHUTI, Burlington, MA (US)

(73) Assignee: RHODIA OPERATIONS, Paris (FR)

(21) Appl. No.: 16/137,783

(22) Filed: Sep. 21, 2018

Related U.S. Application Data
(60) Provisional application No. 62/561,755, filed on Sep. 22, 2017.

(51) Int. Cl. A01N 25/30; A01N 43/80

(52) U.S. Cl. CPC A01N 25/30; A01N 43/80

(57) ABSTRACT

A concentrated adjuvant composition comprises an incompletely hydrated water-soluble polymer suspended in a liquid medium, a suspension agent, a surfactant, optionally, a glycol, glycol derivative, glycerol or glycerol derivative, and a water conditioning component.

### CROSS-REFERENCE TO RELATED APPLICATIONS

This application claims the benefit of U.S. Provisional Patent Application Ser. No. 62/561,755 filed on Sep. 22, 2017, the contents of which is incorporated herein by reference.

### FIELD OF THE INVENTION

This invention relates to formulations having concentrated suspensions of water-soluble polymers and, in particular, to concentrated suspensions of polysaccharide particles.

### BACKGROUND

The application of pesticides and herbicides is important in agriculture to control the growth of weeds, which interfere with the growth of crops. Pesticides/herbicides are sprayed from the air and because of wind, they could be carried to adjacent fields/roads and cause unwanted damage. Drift reducing agents are commonly used to mitigate the drift. Further, the quality of water varies from one place to another and the hardness of water has a significant effect on the efficiency of the pesticide/herbicide, where in harder water the pesticide/herbicide becomes less effective. In order to maintain the efficiency, water conditioners are used. Typically, the water conditioner and the drift reducing agent and two separate additives that will be used and mixed separately into a tank.

### SUMMARY OF THE INVENTION

In the present invention, the water conditioning agents and drift reducing agents are combined together in a single formulation that addresses drawbacks currently present in the industry. Having a built-in water conditioner (i.e., with the drift control agent) has a distinct advantage of automatically managing the water hardness and making sure the efficiency of the pesticide is not lost. This is an advantage to a farmer or end user which no longer needs to measure and apply a ratio to the tank mix, which is often performed erroneously, leading to incompatibility issues and the like. Also, when the water conditioner and drift treatment are used separately, additionally resources are needed such as additive tanks and also additional trips in hauling the equipment in the farm. Having the water conditioner along with the drift reducing agent will also help in saving time for the farmer or end user.

Further, it is common in agricultural applications to add a polymer in the form of a dry powder to an aqueous medium and dissolved to form a viscous aqueous solution. In some applications, it would also be desirable to provide a liquid concentrate that has a high polymer content and that could simply be diluted to the desired end-use concentration for agricultural uses. This approach can be difficult, for example, concentrated aqueous polysaccharide polymer solutions tend to be highly viscous and difficult to handle. Often times, ammonium containing compounds such as ammonium sulphate (AMS), diammonium phosphate (DAP), and urea ammonium nitrate (UAN) can be used to control polysaccharide hydration.

In the agricultural industry, ammonium containing compounds such as ammonium sulphate (AMS), diammonium phosphate (DAP), and urea ammonium nitrate (UAN), among others, are conventionally used to control polysaccharide hydration as well as in water conditioning. Use of AMS, DAP and UAN, among others, have been widely adopted in agricultural practices, especially in “hard water” areas. In these areas, tank mixes containing, as a large component thereof, “hard water” along with pesticides, including herbicides (e.g., glyphosate) and the like, as well as other components.

To combat the rise of glyphosate-resistant weeds, the trend in the agricultural industry has shifted away from utilizing only glyphosate to other herbicides or a combination of glyphosate with other herbicides. Other herbicides, for example, dicamba and its salts, can be utilized. However, dicamba and its salts are generally incompatible with ammonium containing compounds used for water conditioning. As such, it is desirable to replace these ammonium containing compounds with alternative compounds that are compatible with dicamba and its salts. In one embodiment, the compositions as described herein are free of added ammonium containing compounds or are prepared in the absence of ammonium containing compounds. In another embodiment, the composition as described herein are substantially free of ammonium containing compounds, meaning no ammonium containing compounds have been added to the composition. In another embodiment, the composition as described herein are substantially free of ammonium containing compounds, meaning no ammonium containing compounds have been added to the composition wherein only trace amounts of ammonium containing compounds are present. In yet another embodiment, the composition as described herein are substantially free of ammonium containing compounds, meaning only trace amounts of ammonium containing compounds are present.

In one embodiment, trace amount of ammonium containing compounds means less than 2% by weight of composition of ammonium containing compounds are present. In another embodiment, trace amount of ammonium containing compounds means less than 1% by weight of composition of ammonium containing compounds are present. In yet another embodiment, trace amount of ammonium containing compounds means less than 0.5% by weight of composition of ammonium containing compounds are present. In another embodiment, trace amount of ammonium containing compounds means less than 0.1% by weight of composition of ammonium containing compounds are present. In another embodiment, trace amount of ammonium containing compounds means less than 0.05% by weight of composition of ammonium containing compounds are present.

There is also a continuing interest in providing polymers in a convenient form that exhibits good handling properties and good storage stability.

In one aspect, described herein are agricultural compositions comprising: (A) a drift control component (which drift control component comprises: (i) an incompletely hydrated water-soluble polymer suspended in a liquid medium, (ii) a suspending agent in an amount effective to impart shear thinning properties to the composition, (iii) a glycol, a glycol derivative, a glycerol or a glycerol derivative, and (iv) a surfactant) and (B) a water conditioning component comprising: choline chloride, potassium citrate, citric acid, polyacrylate, ethylenediaminetetraacetic acid (EDTA), dipotassium hydrogenphosphate (K₂HPO₄), potassium dihydrogenphosphate (KH₂PO₄), or a combination thereof. It is also understood that the liquid medium can contain a glycol, a glycol derivative, a glycerol or a glycerol derivative.

In another embodiment, described herein are agricultural compositions comprising: (A) a drift control component (which drift control component comprises: (i) an incompletely hydrated water-soluble polymer suspended in a liquid medium, the liquid medium optionally containing a glycol, a glycol derivative, a glycerol or a glycerol derivative, (ii) a suspending agent in an amount effective to impart shear thinning properties to the composition, and (iii) a surfactant) and (B) a water conditioning component comprising: choline chloride, potassium citrate, citric acid, dipotassium hydrogenphosphate (K₂HPO₄), potassium dihydrogenphosphate (KH₂PO₄), or a combination thereof.

The agricultural composition, in one embodiment, is flowable and exhibits a viscosity of less than 10 Pa·s at a shear rate of greater than or equal to 10 s⁻¹. In one embodiment, the agricultural composition is flowable and exhibits a viscosity of less than 1 Pa·s at a shear rate of greater than or equal to 10 s⁻¹. In a further embodiment, the agricultural composition is flowable and exhibits a viscosity of less than 0.1 Pa·s at a shear rate of greater than or equal to 10 s⁻¹.

The water conditioning component can comprise comprises choline chloride as the sole component. In some embodiments, the suspending agent is selected from fumed silica, inorganic colloidal or colloid-forming particles, rheology modifier polymers, or mixtures thereof. In one embodiment, the water-soluble polymer is guar, carboxymethyl guar, carboxymethylhydroxypropyl guar, cationic hydroxypropyl guar, hydroxyethyl guar, hydroxypropyl guar, hydroxybutyl guar, carboxylpropyl guar, carboxybutyl guar, xanthan gum, and mixtures thereof. Typically, in some embodiments, the water-soluble polymer is guar, carboxymethylhydroxypropyl guar, hydroxypropyl guar or any combination thereof.

In some embodiments, the glycol, glycol derivative, glycerol or glycerol derivative is polyethylene glycol, glycol ether or polypropylene glycol, or a combination thereof.

The agricultural composition can further comprise a pesticide active ingredient, wherein the water-soluble polymer or drift control component enhances delivery of the pesticide active ingredient from the liquid medium to a target substrate. The agricultural composition may be incorporated into a pesticide formulation thus providing a “built in” formulation, or, provided as a standalone water conditioning and drift control adjuvant formulation without a pesticide component. These formulations are typically concentrates and would be used by simply adding the desired amount of concentrate to the tank/spray mixture prior to application.

The liquid medium can be an aqueous liquid medium that comprises water or water and a water immiscible organic liquid. Further, in some embodiments, the agricultural composition is in the form of an emulsion, a microemulsion, or a suspoemulsion.

In one embodiment, the surfactant is a C₈-C₁₆ alcohol ethoxylate. In other embodiments, the agricultural composition comprises, based on 100 parts by weight of the composition, at least 2 parts or by weight of an incompletely hydrated water-soluble polymer suspended in a liquid medium. In other embodiments, the agricultural composition comprises, based on 100 parts by weight of the composition, at least 3 parts by weight or at least 4 parts by weight of an incompletely hydrated water-soluble polymer suspended in a liquid medium.

In one embodiment, the suspending agent comprises a microbial polysaccharide. In one embodiment, the suspending agent comprises xanthan gum. In another embodiment, the suspending agent comprises xanthan gum, rheozan, diutan, welan gum, succinoglycan, scleroglucan or other microbial polysaccharide. In another embodiment, the suspending agent is a mixture of (i) fumed silica, precipitated silica and/or (ii) inorganic colloidal or colloid-forming particles. In another embodiment, the suspending agent is a mixture of at least two of the following: fumed silica, precipitated silica, inorganic colloidal particles or colloid-forming particles.

In another aspect, described herein are methods for making an agricultural composition that comprises a mixture of an aqueous liquid medium, an incompletely hydrated water-soluble polymer dispersed in the aqueous liquid medium, and a water conditioning component, the steps comprising: (1) contacting the water conditioning component with the aqueous liquid medium, and (2) contacting a drift control component with the mixture of aqueous liquid and the water conditioning component. In some embodiments, the method further includes the step of contacting an agricultural pesticide compound to the composition.

### DETAILED DESCRIPTION OF INVENTION AND PREFERRED EMBODIMENTS

As used herein, “liquid medium” means a medium that is in the liquid phase at a temperature of 25° C. and a pressure of one atmosphere. The liquid medium may be a non-aqueous liquid medium or an aqueous liquid medium.

In one embodiment, the liquid medium is an aqueous liquid medium. As used herein, the terminology “aqueous medium” means a single phase liquid medium that contains more than a trace amount of water, typically, based on 100 pbw of the aqueous medium, more than 0.1 pbw water. Suitable aqueous media more typically comprise, based on 100 pbw of the aqueous medium, greater than about 5 pbw water, even more typically greater than 10 pbw water. In one embodiment, the aqueous emulsion comprises, based on 100 pbw of the aqueous medium, greater than 40 pbw water, more typically, greater than 50 pbw water. The aqueous medium may, optionally, further comprise water-soluble or water miscible components dissolved in the aqueous medium.

The terminology “water miscible” as used herein means miscible in all proportions with water. Suitable water miscible organic liquids include, for example, (C₁-C₆)alcohols, such as methanol, ethanol, propanol, and (C₁-C₆)polyols, such as glycerol, ethylene glycol, propylene glycol, and diethylene glycol. The composition of the present invention may, optionally, further comprise one or more water insoluble or water immiscible components, such as a water immiscible organic liquid, wherein the combined aqueous medium and water insoluble or water immiscible components form a micro emulsion, or a multi-phase system such as, for example, an emulsion, a suspension or a suspo-emulsion, in which the aqueous medium is in the form of a discontinuous phase dispersed in a continuous phase of the water insoluble or water immiscible component, or, more typically, the water insoluble or water immiscible component is in the form of a discontinuous phase dispersed in a continuous phase of the aqueous medium.

As used herein, the term “hydration” in reference to the water-soluble polymer component of the present invention means association of substituent groups, typically hydrophilic substituent groups, such as hydroxyl groups, of the water-soluble polymer with water molecules, such as water molecules of the aqueous medium through, for example, hydrogen bonding. The degree to which the water-soluble polymer is hydrated can range from non-hydrated to completely hydrated, with degrees of partial hydration extending between the two extremes. As discussed in greater detail below, the water-soluble polymer is capable of contributing to the viscosity of the composition of the present invention with the magnitude of the contribution being dependent on the degree of hydration of the water-soluble polymer. The degree of hydration of the water-soluble polymer can thus be characterized based on the magnitude of the contribution that the water-soluble polymer makes to the viscosity of the composition.

As referred to herein, a “non-hydrated” water-soluble polymer makes no significant contribution to the viscosity of the composition. In general, the non-hydrated water-soluble polymer would be in the form of a discontinuous phase, for example, discrete particles, that is dispersed in a continuous phase of the liquid medium, ideally with no interaction between the hydrophilic substituents of the polymer and any water molecules present in the liquid medium. In the case of an aqueous medium, there will generally be at least some interaction between the hydrophilic groups of the polymer and water molecules of the aqueous medium at interfaces between the phases, for example, at the outer surfaces of the particles. It is believed that in the case of a non-hydrated water-soluble polymer, interaction among the hydrophobic substituent groups of the non-hydrated water-soluble polymer dominates over interaction between the hydrophilic substituent groups of the polymer and any water molecules present in the aqueous medium. The polymer chains of the non-hydrated water-soluble polymer are in a compact, folded conformation, and, in the case where the liquid medium is an aqueous medium, the non-hydrated water-soluble polymer is not dissolved in the aqueous medium and remains in the form of a discontinuous phase dispersed in the continuous phase of the aqueous medium.

As referred to herein, a “completely hydrated” water-soluble polymer makes the maximum contribution to the viscosity of the composition that the water-soluble polymer is capable of making. It is believed that in a completely hydrated water-soluble polymer, association between the hydrophilic substituent groups of the water-soluble polymer and water molecules dominates over interaction among the hydrophobic substituent groups. Thus, the polymer chains of a completely hydrated water-soluble polymer are thus in an unfolded, random coil conformation, and in the case where the liquid medium is an aqueous medium, the aqueous medium and completely hydrated water-soluble polymer form a single phase, that is, the completely hydrated water-soluble polymer is dissolved in the aqueous medium.

As referred to herein, a “partially hydrated” water-soluble polymer is a water-soluble polymer wherein some of the hydrophilic substituent groups of the polymer are associated with water molecules. At a relatively low level of hydration, the partially hydrated water-soluble polymer makes a relatively small contribution to the viscosity of the composition, while at a relatively high level of hydration, the viscosity contribution of a given amount of a partially hydrated water-soluble polymer in a given medium approaches, but is less than, the maximum contribution that the amount of water-soluble polymer is capable of making in that medium when completely hydrated. It is believed that with increasing hydration, particles of the water-soluble polymer swell, an increasing number of hydrophilic substituent groups of the water-soluble polymer, including hydrophilic substituent groups within the mass of swollen water-soluble polymer, become associated with water molecules, and, as complete hydration is approached, the water-soluble polymer chains progressively unfold and approach an unfolded, randomly coiled configuration.

“Non-hydrated” and “partially hydrated” are collectively referred to herein as “incompletely hydrated”.

The degree of hydration of the water-soluble polymer can be characterized by viscosity measurements. For example, the viscosity of a given amount of a water-soluble polymer, in a given amount of an aqueous medium, in the presence of a given amount of a water conditioning component (which also acts to inhibit hydration of the polysaccharide or water-soluble polymer), and under given shear conditions, as described in more detail below (the “test composition”), can be compared to the viscosity of the same amount of the water-soluble polymer in the same amount of the aqueous medium in the absence of the water conditioning component (the “baseline composition”). It is believed that the water conditioning component also contributes to the agricultural composition being incompletely hydrated, or in other embodiments, non-hydrated or partially hydrated. If the viscosity of the test composition is equal to that of the baseline composition, then the water-soluble polymer of the test composition is deemed to be completely hydrated (and the water conditioning component is ineffective in the amount tested to inhibit hydration of the polymer). If the viscosity of the test composition is less than that of the baseline composition, then the water-soluble polymer of the test composition is deemed to be “incompletely hydrated” (and the proposed water conditioning component is effective in the amount tested to inhibit hydration of the polymer).

In one embodiment, the liquid medium is an aqueous liquid medium and at least a portion of the water-soluble polymer is in the form of particles of the water-soluble polymer. In one embodiment, the liquid medium is an aqueous liquid medium, at least a portion of the water-soluble polymer is in the form of particles of the water-soluble polymer, and at least a portion of such particles are dispersed, more typically suspended, in the aqueous liquid medium. The presence of such particles in the composition of the present invention may be detected by, for example, optical microscopy.

In one embodiment, the composition of the present invention exhibits a viscosity of less than 10 Pa·s, more typically from about 0.1 to less than 10 Pa·s, at a shear rate of greater than or equal to 10 s⁻¹. In one embodiment, the composition of the present invention exhibits a viscosity of less than 7 Pa·s, more typically from about 0.1 to less than 7 Pa·s, at a shear rate of greater than or equal to 10 s⁻¹. In one embodiment, the composition of the present invention exhibits a viscosity of less than 5 Pa·s, more typically from about 0.1 to less than 5 Pa·s, at a shear rate of greater than or equal to 10 s⁻¹.

In one embodiment, such a viscosity profile equates to the composition being flowable, i.e., able to be pumped. This characteristic is an advantage as end use applications from a storage container typically prefer to pump components into the final application tank for crop application. For example, typically farmers will add components for a final tax mix into separate tanks, such as a tank for water, a tank for an adjuvant composition, a tank for a water conditioner, and have those components pumped into a final end use application tank.

In one embodiment, the composition of the present invention exhibits a non-Newtonian “shear thinning” viscosity, that is, a viscosity that, within a given range of shear stress, decreases with increasing shear stress. Two general generally recognized categories of flow behavior, that is, plastic flow behavior and pseudoplastic flow behavior, each include shear thinning flow behavior.

In one embodiment, the composition of the present invention exhibits plastic flow behavior. As used herein, the term “plastic” in reference to flow behavior of a composition means the composition that exhibits a characteristic “yield strength”, that is, a minimum shear stress required to initiate flow of the composition, and exhibits shear thinning behavior over some range of shear stress above the yield strength. A plastic composition exhibits no flow when subjected to shear stress below its yield strength, and flows when subjected to shear stress above its yield strength, wherein, over an intermediate range of shear stress above its yield strength, the composition typically exhibits a non-Newtonian viscosity that decreases with increasing shear stress, that is, shear thinning behavior, and, at shear stresses above the intermediate range of shear stress, the composition may exhibit a viscosity that does not vary with shear stress, that is, Newtonian flow behavior.

In one embodiment the composition of the present invention exhibits pseudoplastic flow behavior. As used herein, the term “pseudoplastic” in reference to the flow behavior of a composition means that the composition exhibits a viscosity that decreases with increasing shear stress, that is, shear thinning behavior.

In each case, a composition having plastic or pseudoplastic rheological properties resists flow at low shear stress, but that when subjected to an elevated shear stress, such as being shaken in a bottle or squeezed through an orifice, the composition flows and can be easily pumped, poured, or otherwise dispensed from a container. In general, sedimentation or storage condition is a low shear process, having a shear rate in the range of from about 10⁻⁶ reciprocal seconds (1/s or, equivalently, s⁻¹) to about 0.01 s⁻¹ and pumping or pouring is a relatively high shear process with a shear rate in the range of greater than or equal to about 1 s⁻¹, more typically from 100 s⁻¹ to 10,000 s⁻¹, and even more typically, from 100 s⁻¹ to 1,000 s⁻¹.

In one embodiment, the composition of the present invention comprises from about 1 pbw, or from greater than about 1.5 pbw, or from greater than about 2 pbw, or from greater than about 2.4 pbw, or from greater than about 2.5 pbw—to about 30 pbw, or to about 25 pbw, or to about 20 pbw, or to about 15 pbw, or to about 12 pbw, of the water-soluble polymer and exhibits a viscosity of less than or equal to about 10 Pa·s, more typically from about 0.1 to less than or equal to 10 Pa·s, and even more typically from about 0.1 to less than or equal to 5 Pa·s, at a shear rate of greater than or equal to 10 s⁻¹.

In one embodiment, the composition of the present invention resists sedimentation or separation under low shear stress storage conditions yet is pumpable under elevated shear stress condition. In one such embodiment, the composition of the present invention exhibits a viscosity of from about 1 to about 1000 Pa·s, more typically from 5 to about 800 Pa·s, even more typically from about 10 to about 500 Pa·s, at a shear rate of less than or equal to 0.01 s⁻¹ and exhibits a viscosity that is less than the viscosity exhibited at a shear rate of less than or equal to 0.01 s⁻¹, typically a viscosity of less than 10 Pa·s, more typically from about 0.1 to less than 10 Pa·s, and even more typically from about 0.1 to less than 5 Pa·s, at a shear rate of greater than or equal to 10 s⁻¹, more typically, greater than or equal to 100 s⁻¹.

In one embodiment, the composition of the present invention exhibits a viscosity greater than or equal to 10 Pa·s at a shear rate of less than or equal to 0.01 s⁻¹ and exhibits a viscosity of less than 10 Pa·s at a shear rate of greater than or equal to 10 s⁻¹, more typically, greater than or equal to 100 s⁻¹.

In one embodiment, the composition of the present invention exhibits a viscosity greater than or equal to 5 Pa·s at a shear rate of less than or equal to 0.01 s⁻¹ and exhibits a viscosity of less than 5 Pa·s at a shear rate of greater than or equal to 10 s⁻¹, more typically, greater than or equal to 100 s⁻¹.

In one embodiment, the composition of the present invention exhibits a viscosity greater than or equal to 1 Pa·s at a shear rate of less than or equal to 0.01 s⁻¹ and exhibits a viscosity of less than 1 Pa·s at a shear rate of greater than or equal to 10 s⁻¹, more typically, greater than or equal to 100 s⁻¹.

In one embodiment, the composition exhibits a yield strength of greater than 0 Pa, more typically greater than 0.01 Pa, even more typically from about 0.01 to about 10 Pa, still more typically from about 0.1 to about 5 Pa.

In one embodiment, the composition of the present invention also exhibits thixotropic properties. As used herein, the term “thixotropic” in reference to the flow properties of a composition means that the composition exhibits non-Newtonian shear thinning viscosity that is time dependent, i.e., the decrease in the viscosity of the composition that is brought about by increasing shear stress is reversible and the composition returns to its original state when the shear stress is discontinued.

In one embodiment, the composition of the present invention further comprises a suspending agent, typically dispersed in the liquid medium, in an amount effective to impart shear thinning viscosity, to impart yield strength, or to impart shear thinning viscosity and yield strength to the composition, generally in an amount, based on 100 pbw of the composition of the present invention, of from greater than 0 to about 10 pbw, more typically from about 0.2 to about 5 pbw, and even more typically, from about 0.5 to about 5 pbw of the suspending agent.

In one embodiment, the suspending agent is selected from silica, more typically fumed silica, inorganic colloidal or colloid-forming particles, more typically clays, rheology modifier polymers, and mixtures thereof. In one embodiment, wherein the liquid medium is an aqueous medium, the suspending agent comprises a polysaccharide polymer that differs from the water-soluble polymer and that is more readily hydrolyzed than the water-soluble polymer. For example, xanthan gum may be dissolved in an aqueous medium and used as a suspending agent to suspend incompletely hydrolyzed guar particles in the aqueous medium.

In one embodiment, wherein the liquid medium is an aqueous medium and the water-soluble polymer is incompletely hydrolyzed and itself performs the function of suspending agent by forming a water swollen, viscous mass, said viscous mass having a lower viscosity than would the same amount of the same water-soluble polymer in a fully hydrated state, and a separate suspending agent is not required.

In one embodiment, the composition of the present invention further comprises a water conditioning component.

It is further believed that the water conditioning component can be added in an amount effective to inhibit hydration of the water-soluble polysaccharide in the liquid medium so that the polysaccharide polymer component of the composition of the present invention is incompletely hydrated, generally in an amount, based on 100 pbw of the aqueous medium, of from greater than 0 to about 70 pbw, more typically from about 15 to about 60 pbw, and even more typically, from about 20 to about 50 pbw of the water conditioning component. Use of a water conditioning component is typically of most benefit in those embodiments of the composition of the present invention wherein the liquid medium is an aqueous medium.

In another embodiment, the water conditioning component is present in an amount having a lower limit of, based on 100 pbw of aqueous solution, of 10 pbw, or in another embodiment of 15 pbw, or in another embodiment, 20 pbw, or in another embodiment, 25 pbw.

In a further embodiment, the water conditioning component is present in an amount having an upper limit of, based on 100 pbw of aqueous solution, of 30 pbw, or in another embodiment of 40 pbw, or in another embodiment, 50 pbw, or in another embodiment, 60 pbw, or in another embodiment, 70 pbw.

It will be appreciated that the suspending agent and/or the water conditioning component of the composition of the present invention may each perform more than one function. For example, a suspending agent that functions as a suspending agent in the composition of the present invention may also perform another desired function, for example, hydration inhibitor, drift reduction, etc., in an end use application. Or a salt that functions as a hydration inhibitor in the composition of the present invention may also perform a desired function, for example, biological activity, in an end use application, such as a pharmaceutical or pesticide composition. As another example, a water conditioning component that functions as a water conditioner in the composition of the present invention may also perform a desired function, for example, hydration inhibitor, in the upstream or an end use application.

In one embodiment, the composition of the present invention comprises, based on 100 pbw of the composition, of from greater than 0 pbw, more typically from about 1 pbw, even more typically from about 2 pbw, and still more typically from greater than 2.5 pbw, to about 30 pbw, more typically to about 25, even more typically to about 20 pbw, and still more typically about 12 pbw, of the water-soluble polymer.

In another embodiment, the water-soluble polymer is present in an amount having a lower limit, based on 100 pbw of aqueous solution or composition, of 1 pbw, or in another embodiment of 1.2 pbw, or in another embodiment, 1.4 pbw, or in another embodiment, 1.6 pbw, or in another embodiment, 1.8 pbw, or in yet another further embodiment, 2 pbw, or in another embodiment, 2.4 pbw, or in a further embodiment, 3 pbw, or in another embodiment, 3.5 pbw, or in another embodiment, 3.8 pbw, or in another embodiment, 4 pbw, or in another embodiment, 4.5 pbw, or one embodiment, 5 pbw, or in another embodiment, 7 pbw, or in a further embodiment, 8 pbw, or in another embodiment, 10 pbw, or in yet another embodiment, 12 pbw, or in another embodiment, 16 pbw, or in another embodiment, 20 pbw. In one particular embodiment, the water-soluble polymer is present in an amount having a lower limit, based on 100 pbw of aqueous solution or composition, of 1.8 pbw. In one particular embodiment, the water-soluble polymer is present in an amount having a lower limit, based on 100 pbw of aqueous solution or composition, of 3.8 pbw. In one particular embodiment, the water-soluble polymer is present in an amount having a lower limit, based on 100 pbw of aqueous solution or composition, of 4 pbw. In one particular embodiment, the water-soluble polymer is present in an amount having a lower limit, based on 100 pbw of aqueous solution or composition, of 2 pbw.

In yet another embodiment, the water-soluble polymer is present in an amount having am upper limit, based on 100 pbw of aqueous solution or composition, of 20 pbw, or in another embodiment of 18 pbw, or in another embodiment, 17 pbw, or in another embodiment, 16 pbw, or in another embodiment, 14 pbw, or in yet another further embodiment, 13 pbw, or in another embodiment, 12 pbw, or in a further embodiment, 10 pbw, or in another embodiment, 9 pbw, or in another embodiment, 8 pbw, or in another embodiment, 7 pbw, or in another embodiment, 6 pbw, or one embodiment, 5.5 pbw, or in another embodiment, 5 pbw, or in a further embodiment, 4.5 pbw, or in another embodiment, 3 pbw, or in yet another embodiment, 2.5 pbw, or in another embodiment, 2.2 pbw. In one particular embodiment, the water-soluble polymer is present in an amount having an upper limit, based on 100 pbw of aqueous solution or composition, of 12 pbw. In one particular embodiment, the water-soluble polymer is present in an amount having an upper limit, based on 100 pbw of aqueous solution or composition, of 8 pbw. In one particular embodiment, the water-soluble polymer is present in an amount having an upper limit, based on 100 pbw of aqueous solution or composition, of 20 pbw.

In one embodiment, the polymer is a polysaccharide polymer. Polysaccharide polymer typically have a large number of hydrophilic, typically, hydroxyl, substituent groups, per molecule, more typically one or more hydroxyl group per monomeric unit of the polysaccharide polymer.

In one embodiment, wherein the polysaccharide polymer is a polymer having a weight average molecular weight of up to about 10,000,000 grams per mole (g/mol) more typically of up to about 5,000,000 grams per mole, more typically from about 100,000 to about 4,000,000 g/mol, even more typically from about 500,000 to about 3,000,000 g/mol, the composition of the present invention comprises, based on 100 pbw of the composition, up to about 15 pbw, more typically from about 1 to about 12 pbw, and even more typically, from about 2 to about 10 pbw, and still more typically from greater than 2.5 to about 8 pbw, of the polysaccharide polymer. The weight average molecular weight of a polysaccharide polymer may be determined by known methods, such as by gel permeation chromatography with light scattering or refractive index detection. As generally used herein, i.e., in the absence of an explicit limitation such as “derivatized” or “non-derivatized”, the term “guar polymer” refers collectively to non-derivatized polysaccharide polymers and derivatized polysaccharide polymers.

In one embodiment, wherein the polysaccharide polymer is a depolymerized guar having a molecular weight of less than about 100,000 g/mol, the composition of the present invention comprises, based on 100 pbw of the composition, up to about 50 pbw or to about 30 pbw, more typically from about 0.1 pbw or from about 1 pbw to about 25 pbw, even more typically, from about 1.5 to about 20 pbw, still more typically from about 2 pbw to about 15 pbw, and still more typically greater than 2.5 pbw to about 12 pbw, of the polysaccharide polymer.

In one embodiment, the composition of the present invention comprises from greater than 2.5 to about 8 pbw of a guar polymer suspended in a liquid medium, more typically an aqueous medium, wherein the polymer has a weight average molecular weight of from about 100,000 g/mol, more typically from about 500,000 g/mol, to about 5,000,000 g/mol, more typically to about 4,000,000 g/mol, and even more typically to about 3,000,000 g/mol, and the composition exhibits a viscosity of greater than or equal to 5 Pa·s, more typically greater than or equal to 10 Pa·s, at a shear rate of less than 0.01 s⁻¹, more typically less than 0.001 s⁻¹, and a viscosity that is less than the viscosity exhibited at a shear rate of less than or equal to 0.01 s⁻¹, typically a viscosity of less than 10 Pa·s, more typically less than 5 Pa·s, at a shear rate of greater than 10 s⁻¹, more typically greater than 100 s⁻¹.

In one embodiment, the drift control component of the present invention comprises:
(a) a liquid medium,
(b) an incompletely hydrated water-soluble polymer, more typically wherein at least a portion of a water-soluble polymer is in the form of particles of the water-soluble polymer, at least a portion of which are dispersed, more typically suspended in the liquid medium, and
(c) a suspending agent in an amount effective to impart shear thinning properties to the composition;
(d) optionally, a surfactant; and
(e) optionally, a glycol, a glycol derivative, a glycerol, a glycerol derivative, or any combination thereof.

Glycols, glycol derivatives, glycerols and/or glycerol derivatives include, but are not limited, to polyglycols, polyglycol derivatives, aliphatic dihydroxy (dihydric) alcohols, polypropylene glycol, triethylene glycol, glycol alkyl ethers such as dipropylene glycol methyl ether, diethylene glycol. In another embodiment, glycols, glycol derivatives, glycerols and/or glycerol derivatives include but are not limited to polyglycols such as polyethylene glycols (PEG) and polypropylene glycols. Glycols are represented by the general formula CₙH2ₙ(OH)₂, where n is at least 2. Non-limiting examples of glycols include ethylene glycol (glycol), propylene glycol (1,2-propanediol), 1,4-butanediol, 1,5-pentanediol, 1,6-hexanediol, 1,7-heptanediol, 1,9-nonanediol, 1,10-decanediol, 1,8-octanediol, 1,3-propanediol, 1,3-butanediol, 1,4-butanediol, 2,3-butanediol, 2,4-pentanediol, 2,5-hexanediol, 4,5-octanediol and 3,4-hexanediol, neopenty glycol, pinacol, 2,2-diethyl-1,3-propanediol, 2-ethyl-1,3-hexanediol, 2-ethyl-2-butyl-1,3-propanediol, isobutylene glycol, 2,3-dimethyl-1,3-propanediol, 1,3-diphenyl-1,3-propanediol, 3-methyl-1,3-butanediol.

In another embodiment, glycols, glycol derivatives, glycerols and/or glycerol derivatives include but are not limited to glycol stearate, ethylene glycol monostearate, ethylene glycol distearate, ethylene glycol amido stearate, dilaurate glycol, propylene glycol monostearate, propylene glycol dicaprylate, propylene glycol dicaprate diacetate glycol, dipalmite glycol, diformate glycol, dibutyrate glycol, dibenzorate glycol, dipalmate glycol, dipropionate glycol, monoacetate glycol, monopalmitate glycol and monoformate glycol. In another embodiment, glycols, glycol derivatives, glycerols and/or glycerol derivatives also include polypropylene glycol, triethylene glycol, dipropylene glycol methyl ether, or diethylene glycol.

Polyglycol derivatives include but are not limited to polypropylene glycols, as well as polyethylene glycol (PEG) 200-6000 mono and dilaurates, such as, PEG 600 dilaurate, PEG 600 monolaurate, PEG 1000 dilaurate, PEG 1000 monolaurate, PEG 1540 dilaurate and PEG 1540 monolaurate, polyethylene glycol 200-6000 mono and dioleates, such as, PEG 400 monoleate, PEG 600 dioleate, PEG 600 monooleate, PEG 1000 monoleate, PEG 1540 dioleate, PEG 1540 monooleate and polyethylene glycol 200-6000 mono and distearates, such as, PEG 400 distearate, PEG 400 monostearate, PEG 600 distearate, PEG 600 monostearate, PEG 1000 distearate, PEG 1000 monostearate, PEG 1540 distearate, PEG 1540 monostearate and PEG 3000 monostearate.

Examples of glycerol derivatives include but are not limited to glycerol monolaurate, glycerol monostearate, glycerol distearate, glycerol trioleate, glycerol monooleate, glycerol dilaurate, glycerol dipalmitate, glycerol triacetate, glycerol tribenzoate, glycerol tributyrate, glycerol monopalmitate, glycerol trimyristate, glycerol trilaurate, glycerol tripalmitate and glycerol tristearate.

In one embodiment, the liquid medium is an aqueous medium and composition of the present invention comprises, based on 100 pbw of the composition:
(a) greater than 0 pbw, more typically greater than or equal to about 10 pbw, even more typically greater than or equal to about 30 pbw, and still more typically greater than or equal to about 40 pbw water,
(b) from greater than 0 pbw, more typically from about 0.1 pbw or from about 1 pbw, more typically from about 1.5 pbw, even more typically from about 2 pbw, and still more typically from greater than 2.5 pbw, or from about 3 pbw or from about 4 pbw, to about 50 pbw or to about 30 pbw, more typically to about 25 pbw, more typically to about 20 pbw, even more typically to about 15 pbw, and still more typically, to about 12 pbw, of the incompletely hydrated water-soluble polysaccharide polymer, more typically wherein at least a portion of the water-soluble polymer is in the form of particles, and at least a portion of such particles are dispersed, more typically, suspended, in the liquid medium, and
(c) from greater than 0 pbw, more typically from about 0.1 pbw, even more typically from about 0.2 pbw, and still more typically from about 0.5 pbw, to about 10 pbw and, more typically, to about 5 pbw, of the suspending agent, and
(d) from greater than 0 pbw, more typically from about 0.1 pbw or from about 1 pbw, more typically from about 1.5 pbw, even more typically from about 2 pbw, and still more typically from greater than 2.5 pbw, or from about 3 pbw or from about 4 pbw, to about 50 pbw or to about 40 pbw, more typically to about 30 pbw, more typically to about 25 pbw, even more typically to about 20 pbw of a glycol, a glycol derivative, a glycerol, a glycerol derivative, or any combination thereof.

The drift control component can also comprise in other embodiments, surfactants, water-soluble non-surfactant salts, water dispersible organic solvents, and mixtures thereof. The terminology “non-surfactant salts” as used herein means salts that are not anionic, cationic, zwitterionic or amphoteric surfactants and includes active ingredients, such as a pesticidal active ingredient or a pharmaceutical active ingredient, that are salts and whose primary activity is other than modification of interfacial surface tension. The terminology “water dispersible organic solvents” includes water miscible organic liquids and water immiscible organic liquids that may be dispersed in water, such as for example, in the form of an emulsion of the water immiscible organic liquid in water.

In one embodiment, the composition of the present invention comprises:
(a) a drift control component as described herein; and
(d) a water conditioning component.

In one embodiment, the water conditioning component, in addition to conditioning water, also is able to inhibit hydration of the water-soluble polysaccharide in the aqueous medium. Water conditioners preserve the efficacy of herbicides but do not result in a more volatile herbicide formulation. It is known that water hardness reduces the efficacy of herbicides, including but not limited to glyphosate and other non-auxin herbicides, and the water conditioning component as described herein minimizes the deleterious effect of water soluble cations on, for example, glyphosate and these other non-auxin herbicides.

In one embodiment, the composition of the present invention comprises, based on 100 pbw of the composition:
(a) greater than 0 pbw, more typically greater than or equal to about 10 pbw, even more typically greater than or equal to about 30 pbw, and still more typically greater than or equal to about 40 pbw, water,
(b) from greater than 0 pbw, more typically from about 0.1 pbw or from about 1 pbw, more typically from about 1.5 pbw, even more typically from about 2 pbw, and still more typically from greater than 2.5 pbw, or from about 3 pbw or from about 4 pbw, to about 50 pbw or to about 30 pbw, more typically to about 25 pbw, more typically to about 20 pbw, even more typically, to about 15 pbw, and still more typically, to about 12 pbw, of the incompletely hydrated polysaccharide polymer, more typically wherein at least a portion of the water-soluble polymer is in the form of particles, and at least a portion of such particles are dispersed, more typically, suspended, in the liquid medium,
(c) from greater than 0 pbw, more typically from about 0.1 pbw, even more typically from about 0.2 pbw, and still more typically from about 0.5 pbw, to about 10 pbw and, and more typically to about 5 pbw, of the suspending agent,
(d) from greater than 0 to about 10 pbw, more typically from about 0.1 to about 10 pbw, even more typically from about 0.2 to about 5 pbw, and still more typically, from about 1 to about 4 pbw, of surfactant, and
(e) from greater than 0 pbw, more typically from about 10 pbw, even more typically from about 15 pbw, and still more typically from about 20 pbw, to about 80 pbw, more typically to about 70 pbw, and even more typically to about 60 pbw, of the water conditioning component.

In one embodiment, the composition of the present invention comprises, based on 100 pbw of the composition:
(a) greater than 0 pbw, more typically greater than or equal to about 10 pbw, even more typically greater than or equal to about 30 pbw, and still more typically greater than or equal to about 40 pbw, water,
(b) from greater than 0 or from about 0.1 pbw to about 50 pbw or to about 30 pbw, more typically from about 1 to about 25 pbw, more typically, from about 1.5 to about 20 pbw, even more typically, from about 2 to about 15 pbw, and still more typically from greater than 2.5 to about 12 pbw, of the incompletely hydrated polysaccharide polymer, more typically wherein at least a portion of the water-soluble polymer is in the form of particles, and at least a portion of such particles are dispersed, more typically, suspended, in the liquid medium,
(c) from greater than 0 to about 10 pbw, more typically from about 0.1 to about 10 pbw, even more typically from about 0.2 to about 5 pbw, and still more typically, from about 1 to about 4 pbw, of surfactant,
(d) from greater than 0 to about 10 pbw, more typically from about 0.1 to about 10 pbw, even more typically from about 0.2 to about 5 pbw, and still more typically, from about 0.5 to about 5 pbw, of the suspending agent, and
(e) from greater than 0 to about 70 pbw, more typically from about 10 to about 70 pbw, even more typically from about 15 to about 60 pbw, and still more typically from about 20 to about 50 pbw, of the water conditioning component.

In one embodiment, the suspending agent is a silica and the water conditioning component is choline chloride, polyacrylate, EDTA, potassium citrate, citric acid, dipotassium hydrogenphosphate (K2HPO4), potassium dihydrogenphosphate (KH2PO4), or a combination thereof. The water conditioning component can further comprise a non-surfactant salt, a surfactant, a water dispersible organic solvent, a mixture of a non-surfactant salt and a surfactant, a mixture of a non-surfactant salt and a water dispersible organic solvent, or a mixture of a non-surfactant salt, a surfactant, and a water dispersible organic solvent. In another embodiment, the water conditioning component is choline chloride, tripotassium citrate monohydrate, polyacrylate, EDTA, potassium citrate, citric acid, dipotassium hydrogenphosphate (K2HPO4), potassium dihydrogenphosphate (KH2PO4), or a combination thereof.

In one embodiment, the suspending agent is a silica. In one embodiment, the suspending agent is a clay.

In one embodiment, the suspending agent is a clay and the water conditioning component is choline chloride, polyacrylate, EDTA, potassium citrate, citric acid, dipotassium hydrogenphosphate (K2HPO4), potassium dihydrogenphosphate (KH2PO4), or a combination thereof. In one embodiment, the suspending agent is a silica and the water conditioning component is choline chloride, potassium citrate, polyacrylate, EDTA, citric acid, dipotassium hydrogenphosphate (K2HPO4), potassium dihydrogenphosphate (KH2PO4), or a combination thereof.

In one embodiment, the suspending agent is a mixture of a silica and a clay

In one embodiment, the composition of the present invention comprises, based on 100 pbw of the composition:

from greater than 0 pbw, or greater than or equal to about 10 pbw, of or greater than or equal about 30 pbw of an aqueous medium, more typically water or a mixture of water and a water miscible organic liquid,

from greater than 2.5 pbw, or from about 3 pbw, or from about 4 pbw to about 50 pbw, or to about 30 pbw, or to about 25 pbw, or to about 20 pbw, or to about 15 pbw, or to about 12 pbw, of a water-soluble polymer, more typically a water-soluble polymer selected from water-soluble polysaccharide polymers and water-soluble non-polysaccharide polymers, and even more typically a water-soluble polymer selected from polyacrylamide polymers, non-derivatized guars, derivatized guars, and mixtures thereof, wherein such water-soluble polymer is incompletely hydrated, more typically wherein at least a portion of the water-soluble polymer is in the form of particles and at least a portion of such particles are dispersed, more typically, suspended, in the liquid medium,

from 0 pbw, or from greater than 0 pbw, or from about 0.1 pbw, or from about 0.2 pbw, or from about 0.5 pbw, to about 10 pbw, or to about 5 pbw, of a suspending agent, more typically of a suspending agent selected from silicas, inorganic colloidal or colloid-forming particles, rheology modifier polymers, water-soluble polymers other than the water-soluble polymer, and mixtures thereof dissolved or dispersed in the liquid medium,

from greater than 0 to about 10 pbw, more typically from about 0.1 to about 10 pbw, even more typically from about 0.2 to about 5 pbw, and still more typically, from about 1 to about 4 pbw, of surfactant comprising a C₆-C₁₈ alcohol ethoxylate and its sulfate or phosphate salts,

from greater than 0 pbw, more typically from about 10 pbw, even more typically from about 15 pbw, and still more typically from about 20 pbw, to about 80 pbw, more typically to about 70 pbw, and even more typically to about 60 pbw, of water conditioning component comprising choline chloride, potassium citrate, citric acid, polyacrylate, EDTA, dipotassium hydrogenphosphate (K2HPO4), potassium dihydrogenphosphate (KH2PO4), or a combination thereof.

In one embodiment, the surfactant is added to incorporate desired properties in the application such as, dispersant, wetting agent, biological efficacy agent, spreader, sticker. In one embodiment, the surfactants generally include non-ionic surfactants, or anionic or cationic surfactants. In one embodiment, the surfactant includes but is not limited to, for example, amides such as alkanalkanolamides, ethoxylated alkanolamides, ethylene bisamides; esters such as fatty acid esters, glycerol esters, ethoxylated fatty acid esters, sorbitan esters, ethoxylated sorbitan; ethoxylates such as alkylphenol ethoxylates, alcohol ethoxylates, tristyrylphenol ethoxylates, mercaptan ethoxylates; end-capped and EO/PO block copolymers such as ethylene oxide/propylene oxide block copolymers, chlorine capped ethoxylates, tetra-functional block copolymers; amine oxides such lauramine oxide, cocamine oxide, stearamine oxide, stearamidopropylamine oxide, palmitamidopropylamine oxide, decylamine oxide;mono ester sulfosuccinates, diester sulfosuccinates such as sodium dioctyl sulfosuccinate, sodium bistridecyl sulfosuccinate, sodium dihexyl sulfosuccinate, sodium diisobutyl sulfosuccinate, disodium ethoxylated alcohol half ester of sulfosuccinic acid; fatty alcohols such as decyl alcohol, lauryl alcohol, tridecyl alcohol, myristyl alcohol, cetyl alcohol, stearyl alcohol, oleyl alcohol, linoleyl alcohol and linolenyl alcohol; and alkoxylated alcohols such as ethoxylated lauryl alcohol, trideceth alcohols; and fatty acids such as lauric acid, oleic acid, stearic acid, myristic acid, cetearic acid, isostearic acid, linoleic acid, linolenic acid, ricinoleic acid, elaidic acid, arichidonic acid, myristoleic acid, as well as mixtures thereof. In another embodiment, the non-ionic surfactant is a glycol such as polyethylene glycol (PEG), alkyl PEG esters, polypropylene glycol (PPG) and derivatives thereof. In certain embodiments, the surfactant is a blend of: one or more alcohol ethoxylates, one or more alkyl phenol ethoxylates, one or more terpene alkoxylates, or any mixture thereof. In one exemplary embodiment, the surfactant is a C₆-C₁₃ alcohol ethoxylate and, more typically, a C₈-C₁₂ alcohol ethoxylate.

In one embodiment, the composition of the present invention comprises, based on 100 parts by weight of the composition:

from greater than 0 pbw, or greater than or equal to about 10 pbw, or greater than or equal to about 30 pbw an aqueous liquid medium comprising a mixture of water and a water immiscible organic liquid,

an surfactant, more typically one or more surfactants comprising a nonionic surfactant, even more typically comprising a nonionic surfactant selected from sorbitan fatty acid esters, aryl alkoxylates, alkoxylated fatty alcohols, alkoxylated fatty acids, alkoxylated triglycerides, alkoxy copolymers, alkylpolyglucosides, alkoxylated fatty amines, and ether amines, and, and mixtures thereof, in an amount effective to emulsify the water and water immiscible organic liquid, more typically from greater than 0 pbw, or from about 2 pbw, to about 8 pbw or to about 6 pbw, of the surfactant,

from 0 pbw, or from greater than 0 pbw, or from about 0.1 pbw, or from about 1 pbw, or from about 1.5 pbw, or from about 2 pbw, or from greater than 2.5 pbw, or from about 4 pbw, to about 50 pbw to about 30 pbw, or to about 25 pbw, or to about 20 pbw, or to about 15 pbw, or to about 12 pbw, of a first water-soluble polymer, more typically a water-soluble polymer selected from water-soluble polysaccharide polymers and water-soluble non-polysaccharide polymers, and even more typically a water-soluble polymer selected from polyacrylamide polymers, non-derivatized guars, derivatized guars, and mixtures thereof, wherein such water-soluble polymer is incompletely hydrated, more typically wherein at least a portion of the water-soluble polymer is in the form of particles of the water-soluble polymer and wherein at least a portion of such particles is dispersed, more typically, suspended, in the liquid medium,

from 0 pbw, or from greater than 0 pbw, or from about 0.1 pbw, or from about 0.2 pbw, or from about 0.5 pbw, to about 10 pbw, or to about 5 pbw, of a suspending agent selected from silicas, inorganic colloidal or colloid-forming particles, rheology modifier polymers, second water-soluble polymers other than the selected first water-soluble polymer, and mixtures thereof dissolved or dispersed in the liquid medium, and

from 0 pbw, or from greater than 0 pbw, or from about 2 pbw, or from about 5 pbw, to about 30 pbw or to about 15 pbw, or to about 10 pbw, of a water conditioning component dissolved or dispersed in the liquid medium,

wherein the composition is in the form of an emulsion, a microemulsion, or a suspoemulsion.

In one embodiment, the composition of the present invention comprises, based on 100 parts by weight of the composition:

from greater than 0 pbw, or greater than or equal to about 10 pbw, or greater than or equal to about 30 pbw of a non-aqueous liquid medium, more typically of a water immiscible organic liquid,

from greater than 0 pbw, or from about 0.1 pbw, or from about 1 pbw, or from about 1.5 pbw, or from about 2 pbw, or from greater than 2.5 pbw, or from about 4 pbw, to about 50 pbw, or to about 30 pbw, or to about 25 pbw, or to about 20 pbw, or to about 15 pbw, or to about 12 pbw, of a water-soluble polymer, more typically a water-soluble polymer selected from water-soluble polysaccharide polymers and water-soluble non-polysaccharide polymers, and even more typically a water-soluble polymer selected from polyacrylamide polymers, non-derivatized guars, derivatized guars, and mixtures thereof, wherein at least a portion of the water-soluble polymer is in the form of particles and at least a portion of such particles are dispersed, more typically, suspended, in the non-aqueous liquid medium, and

from 0 pbw, or from greater than 0 pbw, or from about 0.1 pbw, or from about 0.2 pbw, or from about 0.5 pbw, to about 10 pbw or to about 5 pbw, of a suspending agent, more typically a suspending agent selected from selected from silicas, inorganic colloidal or colloid-forming particles, and mixtures thereof, dispersed in the non-aqueous liquid medium.

Suitable water-soluble polysaccharide polymers are include, for example, galactomannans such as guars, including guar derivatives, xanthans, polyfructoses such as levan, starches, including starch derivatives, such as amylopectin, and cellulose, including cellulose derivatives, such as methylcellulose, ethylcellulose, carboxymethylcellulose, hydroxyethylcellulose, cellulose acetate, cellulose acetate butyrate, and cellulose acetate propionate.

Galactomannans are polysaccharides consisting mainly of the monosaccharides mannose and galactose. The mannose-elements form a chain consisting of many hundreds of (1,4)-β-D-mannopyranosyl-residues, with 1,6 linked α-D-galactopyranosyl-residues at varying distances, dependent on the plant of origin. Naturally occurring galactomannans are available from numerous sources, including guar gum, guar splits, locust bean gum and tara gum. Additionally, galactomannans may also be obtained by classical synthetic routes or may be obtained by chemical modification of naturally occurring galactomannans.

Guar gum refers to the mucilage found in the seed of the leguminous plant Cyamopsis tetragonolobus. The water-soluble fraction (85%) is called “guaran,” which consists of linear chains of (1,4)-.β-D mannopyranosyl units-with α-D-galactopyranosyl units attached by (1,6) linkages. The ratio of D-galactose to D-mannose in guaran is about 1:2. Guar gum typically has a weight average molecular weight of between 2,000,000 and 5,000,000 g/mol. Guars having a reduced molecular weight, such as for example, from about 50,000 to about 2,000,000 g/mol are also known.

Guar seeds are composed of a pair of tough, non-brittle endosperm sections, hereafter referred to as “guar splits,” between which is sandwiched the brittle embryo (germ). After dehulling, the seeds are split, the germ (43-47% of the seed) is removed by screening, and the splits are ground. The ground splits are reported to contain about 78-82% galactomannan polysaccharide and minor amounts of some proteinaceous material, inorganic non-surfactant salts, water-insoluble gum, and cell membranes, as well as some residual seedcoat and embryo.

Locust bean gum or carob bean gum is the refined endosperm of the seed of the carob tree, Ceratonia siliqua. The ratio of galactose to mannose for this type of gum is about 1:4. Locust bean gum is commercially available.

Tara gum is derived from the refined seed gum of the tara tree. The ratio of galactose to mannose is about 1:3. Tara gum is commercially available.

Other galactomannans of interest are the modified galactomannans, including derivatized guar polymers, such as carboxymethyl guar, carboxymethylhydroxypropyl guar, cationic hydroxypropyl guar, hydroxyalkyl guar, including hydroxyethyl guar, hydroxypropyl guar, hydroxybutyl guar and higher hydroxylalkyl guars, carboxylalkyl guars, including carboxymethyl guar, carboxylpropyl guar, carboxybutyl guar, and higher carboxyalkyl guars, the hydroxyethylated, hydroxypropylated and carboxymethylated derivative of guaran, the hydroxethylated and carboxymethylated derivatives of carubin, and the hydroxypropylated and carboxymethylated derivatives of cassia-gum. In one embodiment, the derivatized guar is hydroxypropyl guar. In one embodiment, the derivatized guar is cationic hydroxypropyl guar or cationic guar.

Xanthans of interest are xanthan gum and xanthan gel. Xanthan gum is a polysaccharide gum produced by Xathomonas campestris and contains D-glucose, D-mannose, D-glucuronic acid as the main hexose units, also contains pyruvate acid, and is partially acetylated.

Levan is a polyfructose comprising 5-membered rings linked through β-2,6 bonds, with branching through β-2,1 bonds. Levan exhibits a glass transition temperature of 138° C. and is available in particulate form. At a molecular weight of 1-2 million, the diameter of the densely-packed spherulitic particles is about 85 nm.

Modified celluloses are celluloses containing at least one functional group, such as a hydroxy group, hydroxycarboxyl group, or hydroxyalkyl group, such as for example, hydroxymethyl cellulose, hydroxyethyl celluloses, hydroxypropyl celluloses or hydroxybutyl celluloses.

Processes for making derivatives of guar gum splits are generally known. Typically, guar splits are reacted with one or more derivatizing agents under appropriate reaction conditions to produce a guar polysaccharide having the desired substituent groups. Suitable derivatizing reagents are commercially available and typically contain a reactive functional group, such as an epoxy group, a chlorohydrin group, or an ethylenically unsaturated group, and at least one other substituent group, such as a cationic, nonionic or anionic substituent group, or a precursor of such a substituent group per molecule, wherein substituent group may be linked to the reactive functional group of the derivatizing agent by bivalent linking group, such as an alkylene or oxyalkylene group. Suitable cationic substituent groups include primary, secondary, or tertiary amino groups or quaternary ammonium, sulfonium, or phosphinium groups. Suitable nonionic substituent groups include hydroxyalkyl groups, such as hydroxypropyl groups. Suitable anionic groups include carboxyalkyl groups, such as carboxymethyl groups. The cationic, nonionic and/or anionic substituent groups may be introduced to the guar polysaccharide chains via a series of reactions or by simultaneous reactions with the respective appropriate derivatizing agents.

The guar may be treated with a crosslinking agent, such for example, borax (sodium tetra borate) is commonly used as a processing aid in the reaction step of the water-splits process to partially crosslink the surface of the guar splits and thereby reduces the amount of water absorbed by the guar splits during processing. Other crosslinkers, such as, for example, glyoxal or titanate compounds, are known.

In one embodiment, the polysaccharide component of the composition of the present invention is a non-derivatized galactomannan polysaccharide, more typically a non-derivatized guar gum.

In one embodiment, the polysaccharide is a derivatized galactomannan polysaccharide that is substituted at one or more sites of the polysaccharide with a substituent group that is independently selected for each site from the group consisting of cationic substituent groups, nonionic substituent groups, and anionic substituent groups.

In one embodiment, the polysaccharide component of the composition of the present invention is derivatized galactomannan polysaccharide, more typically a derivatized guar. Suitable derivatized guars include, for example, hydroxypropyl trimethylammonium guar, hydroxypropyl lauryldimethylammonium guar, hydroxypropyl stearyldimethylammonium guar, hydroxypropyl guar, carboxymethyl guar, guar with hydroxypropyl groups and hydroxypropyl trimethylammonium groups, guar with carboxymethyl hydroxypropyl groups and mixtures thereof.

The amount of derivatizing groups in a derivatized polysaccharide polymer may be characterized by the degree of substitution of the derivatized polysaccharide polymer or the molar substitution of the derivatized polysaccharide polymer.

As used herein, the terminology “degree of substitution” in reference to a given type of derivatizing group and a given polysaccharide polymer means the number of the average number of such derivatizing groups attached to each monomeric unit of the polysaccharide polymer. In one embodiment, the derivatized galactomannan polysaccharide exhibits a total degree of substitution (“DS_{T}”) of from about 0.001 to about 3.0, wherein:

DS_{T} is the sum of the DS for cationic substituent groups (“DS_{cationic}”), the DS for nonionic substituent groups (“DS_{nonionic}”) and the DS for anionic substituent groups (“DS_{anionic}”),

DS_{cationic} is from 0 to about 3, more typically from about 0.001 to about 2.0, and even more typically from about 0.001 to about 1.0,

DS_{nonionic} is from 0 to 3.0, more typically from about 0.001 to about 2.5, and even more typically from about 0.001 to about 1.0, and

DS_{anionic} is from 0 to 3.0, more typically from about 0.001 to about 2.0.

As used herein, the term “molar substitution” or “ms” refers to the number of moles of derivatizing groups per moles of monosaccharide units of the guar. The molar substitution can be determined by the Zeisel-GC method. The molar substitution utilized by the present invention is typically in the range of from about 0.001 to about 3.

In one embodiment, the polysaccharide polymer is in the form of particles. In one embodiment, the particles of polysaccharide polymer have an initial, that is, determined for dry particles prior to suspension in the aqueous medium, average particle size of about 5 to 200 μm, more typically about 20 to 200 μm as measured by light scattering, and exhibit a particle size in the aqueous medium of greater than or equal to the initial particle size, that is greater than or equal to 5 μm, more typically greater or equal to than 20 μm, with any increase from the initial particle size being due to swelling brought about by partial hydration of the polysaccharide polymer in the aqueous medium.

In one embodiment, the water-soluble polymer is a water-soluble non-polysaccharide polymer. Suitable water-soluble non-polysaccaharide polymers include, for example, lecithin polymers, poly(alkyleneoxide) polymers, such as poly(ethylene oxide) polymers, and water-soluble polymers derived from ethylenically unsaturated monomers. Suitable water-soluble polymers derived from ethylenically unsaturated monomers include water-soluble polymers derived from acrylamide, methacrylamide, 2-hydroxy ethyl acrylate, and/or N-vinyl pyrrolidone, including homopolymers of such monomers, such as poly(acrylamide) polymers and poly(vinyl pyrrolidone) polymers, as well as copolymers of such monomers with one or more comonomers. Suitable water-soluble copolymers derived from ethylenically unsaturated monomers include water-soluble cationic polymers made by polymerization of at least one cationic monomer, such as a diamino alkyl (meth)acrylate or diamino alkyl (meth)acrylamide, or mixture thereof and one or more nonionic monomers, such as acrylamide or methacrylamide. In one embodiment, the non-polysaccharide polymer exhibits a weight average molecular weight of greater than about 1,000,000 g/mol, more typically greater than about 2,000,000 g/mol to about 20,000,000 g/mol, more typically to about 10,000,000 g/mol.

In one embodiment, the suspending agent component of the composition of the present invention comprises a fumed silica. Fumed silica is typically produced by the vapor phase hydrolysis of a silicon compound, e.g., silicon tetrachloride, in a hydrogen oxygen flame. The combustion process creates silicon dioxide molecules that condense to form particles. The particles collide, attach, and sinter together. The result of these processes is typically a three dimensional branched chain aggregate, typically having an average particles size of from about 0.2 to 0.3 micron. Once the aggregates cool below the fusion point of silica (1710° C.), further collisions result in mechanical entanglement of the chains, termed agglomeration.

In one embodiment, suitable fumed silica has a BET surface area of from 50-400 square meters per gram (m²/g), more typically from, from about 100 m²/g to about 400 m²/g.

In one embodiment, the suspending agent component of the composition of the present invention comprises a fumed silica in an amount that is effective, either alone or in combination with one or more other suspending agents, to impart shear thinning viscosity to the composition, typically in an amount, based on 100 pbw of the composition, of from greater than 0 pbw, more typically from about 0.1 pbw, and even more typically from about 0.5 pbw, to about 10 pbw, more typically to about 5 pbw, and even more typically to about 2.5 pbw, of fumed silica.

In one embodiment, the composition of the present invention comprises, based on 100 pbw of the composition, from greater than 0 to about 10 pbw, more typically from about 0.1 to about 5 pbw, and even more typically from about 0.5 to about 2.5 pbw, of fumed silica.

In one embodiment, the suspending agent component of the composition of the present invention comprises an inorganic, typically aluminosilicate or magnesium silicate, colloid-forming clay, typically, a smectite (also known as montmorillonoid) clay, an attapulgite (also known as palygorskite) clay, or a mixture thereof. These clay materials can be described as expandable layered clays, wherein the term “expandable” as used herein in reference to such clay relates to the ability of the layered clay structure to be swollen, or expanded, on contact with water.

Smectites are three-layered clays. There are two distinct classes of smectite-type clays. In the first class of smectites, aluminum oxide is present in the silicate crystal lattice and the clays have a typical formula of Al₂(Si₂O₅)₂(OH)₂. In the second class of smectites, magnesium oxide is present in the silicate crystal lattice and the clays have a typical formula of Mg₃(Si₂O₅)(OH)₂. The range of the water of hydration in the above formulas can vary with the processing to which the clay has been subjected. This is immaterial to the use of the smectite clays in the present compositions in that the expandable characteristics of the hydrated clays are dictated by the silicate lattice structure. Furthermore, atomic substitution by iron and magnesium can occur within the crystal lattice of the smectites, while metal cations such as Na⁺, Ca⁺², as well as H⁺, can be present in the water of hydration to provide electrical neutrality. Although the presence of iron in such clay material is preferably avoided to minimize chemical interaction between clay and optional composition components, such cation substitutions in general are immaterial to the use of the clays herein since the desirable physical properties of the clay are not substantially altered thereby.

The layered expandable aluminosilicate smectite clays useful herein are further characterized by a dioctahedral crystal lattice, whereas the expandable magnesium silicate smectite clays have a trioctahedral crystal lattice.

Suitable smectite clays, include, for example, montmorillonite (bentonite), volchonskoite, nontronite, beidellite, hectorite, saponite, sauconite and vermiculite, are commercially available.

Attapulgites are magnesium-rich clays having principles of superposition of tetrahedral and octahedral unit cell elements different from the smectites. An idealized composition of the attapulgite unit cell is given as: (H₂O)₄(OH)₂Mg₅Si₈O₂0₄H₂O. Attapulgite clays are commercially available.

As noted above, the clays employed in the compositions of the present invention contain cationic counter ions such as protons, sodium ions, potassium ions, calcium ions, magnesium ions and the like. It is customary to distinguish between clays on the basis of one cation which is predominately or exclusively absorbed. For example, a sodium clay is one in which the absorbed cation is predominately sodium. Such absorbed cations can become involved in exchange reactions with cations present in aqueous solutions.

Commercially obtained clay materials can comprise mixtures of the various discrete mineral entities. Such mixtures of the minerals are suitable for use in the present compositions. In addition, natural clays sometimes consist of particles in which unit layers of different types of clay minerals are stacked together (interstratification). Such clays are called mixed layer clays, and these materials are also suitable for use herein.

In one embodiment, suspending agent component of the composition of the present invention comprises an inorganic colloid forming clay in an amount that is effective, either alone or in combination with one or more other suspending agents, to impart shear thinning viscosity to the composition, typically in an amount, based on 100 pbw of the composition, of from greater than 0 pbw, more typically from about 0.1 pbw, and even more typically from about 0.5 pbw, to about 10 pbw, more typically to about 5 pbw, and even more typically to about 2.5 pbw, of inorganic colloid forming clay.

In one embodiment, the composition of the present invention comprises, based on 100 pbw of the composition, from greater than 0 to about 10 pbw, more typically from about 0.1 to about 5 pbw, and even more typically from about 0.5 to about 2.5 pbw, of inorganic colloid forming clay.

A fumed silica or clay suspending agent is typically introduced to the liquid medium and mixed to disperse the fumed silica or clay suspending agent in the liquid medium.

In one embodiment, the suspension agent component of the composition of the present invention comprises a rheology modifier polymer. Rheology modifier polymers are polymers used to thicken aqueous compositions. Suitable rheology modifier polymers are known and typically fall within one of three general classes, that is, alkali swellable polymers, hydrogen bridging rheology modifiers, and hydrophobic associative thickeners.

Alkali swellable polymers are pH-responsive polymers that swell when placed in an alkali medium and include, for example, homopolymers and copolymers comprising units derived from ethylenically unsaturated carboxylic acid monomers such as acrylic acid, methacrylic acid, maleic acid.

Suitable hydrogen bridging rheology modifiers include, for example, hydrocolloids such as cellulose and hydrophilic cellulose derivatives, such as carboxymethylcellulose and hydroxyethylcellulose, and natural gums and gum derivatives, such as guar gum, hydroxypropyl guar, carrageenan and microbial polysaccharide such as xanthan gum, rheozan, diutan, welan gum, succinoglycan, scleroglucan. In one embodiment, the hydrogen bridging rheology modifier is a second water-soluble polymer that is different from the incompletely hydrated water-soluble polymer component of the composition of the present invention. For example, in an embodiment wherein the incompletely hydrated water-soluble polymer is a first polysaccharide polymer, the hydrogen bridging rheology modifier may be a second polysaccharide polymer that is more readily hydrated than the first polysaccharide polymer.

Suitable hydrophobic associative rheology modifiers are known and include hydrophobically modified natural or synthetic polymers that contain both hydrophobic and hydrophilic substituent groups, such as hydrophobically modified cellulose derivatives and polymers having a synthetic hydrophilic polymer backbone, such as a poly(oxyalkylene), such as a poly(oxyethylene) or poly(oxypropylene) backbone and hydrophobic pendant groups, such as (C₁₀-C₃₀) hydrocarbon groups. Nonionic associate thickeners are typically preferred, due to their relative insensitivity to high salt concentrations, and include, for example, PEG-200 glyceryl tallowate, PEG-200 hydrogenated glyceryl palmate, PPG-14 palmeth-60 hexyl dicarbamate, PEG-160 sorbitan triisostearate.

In one embodiment, the suspending agent component of the composition of the present invention comprises a rheology modifier polymer in an amount that is effective, either alone or in combination with one or more other suspending agents, to impart shear thinning viscosity to the composition, typically in an amount, based on 100 pbw of the composition, of from greater than 0 pbw, more typically from about 0.1 pbw, and even more typically from about 1 pbw, to about 10 pbw, more typically to about 5 pbw, of rheology modifier polymer.

In one embodiment, the composition of the present invention comprises, based on 100 pbw of the composition, from greater than 0 to about 10 pbw, more typically from about 0.1 to about 10 pbw, and even more typically from about 1 to about 5 pbw, of rheology modifier polymer.

A rheology modifier suspending agent is typically introduced to the liquid medium and subjected mixing to disperse the rheology modifier polymer in the aqueous medium.

In one embodiment, the composition of the present invention further comprises a surfactant. As used herein the term “surfactant” means a compound that is capable of lowering the surface tension of water, more typically, a compound selected from one of five classes of compounds, that is, cationic surfactants, anionic surfactants, amphoteric surfactants, zwitterionic surfactants, and nonionic surfactants, as well as mixtures thereof, that are known for their detergent properties. In one embodiment, the surfactant is added to incorporate desired properties in the application such as dispersant, wetting agent, biological efficacy agent, spreader, and/or sticker properties.

Suitable cationic surfactants include, for example, amine salts, such as, ethoxylated tallow amine, cocoalkylamine, and oleylamine, quaternary ammonium compounds such as cetyl trimethyl ammonium bromide, myristyl trimethyl ammonium bromide, stearyl dimethyl benzyl ammonium chloride, lauryl/myristryl trimethyl ammonium methosulfate, stearyl octyldimonium methosulfate, dihydrogenated palmoylethyl hydroxyethylmonium methosulfate, isostearyl benzylimidonium chloride, cocoyl benzyl hydroxyethyl imidazolinium chloride, cocoyl hydroxyethylimidazolinium, and mixtures thereof.

Suitable anionic surfactants include, for example, ammonium lauryl sulfate, ammonium laureth sulfate, triethylamine lauryl sulfate, triethylamine laureth sulfate, triethanolamine lauryl sulfate, triethanolamine laureth sulfate, monoethanolamine lauryl sulfate, monoethanolamine laureth sulfate, diethanolamine lauryl sulfate, diethanolamine laureth sulfate, lauric monoglyceride sodium sulfate, sodium lauryl sulfate, sodium laureth sulfate, potassium lauryl sulfate, potassium laureth sulfate, sodium lauryl sarcosinate, sodium lauroyl sarcosinate, lauryl sarcosine, cocoyl sarcosine, ammonium cocoyl sulfate, ammonium lauroyl sulfate, phosphate esters, sodium cocoyl sulfate, sodium lauroyl sulfate, potassium cocoyl sulfate, potassium lauryl sulfate, triethanolamine lauryl sulfate, triethanolamine lauryl sulfate, monoethanolamine cocoyl sulfate, monoethanolamine lauryl sulfate, sodium tridecyl benzene sulfonate, sodium dodecyl benzene sulfonate, mono ester sulfosuccinates, diester sulfosuccinates such as sodium dioctyl sulfosuccinate, sodium bistridecyl sulfosuccinate, sodium dihexyl sulfosuccinate, sodium diisobutyl sulfosuccinate, disodium ethoxylated alcohol half ester of sulfosuccinic acid and mixtures thereof. In one embodiment, suitable surfactants include sulfosuccinates and/or salts thereof. In another embodiment, suitable surfactants include sulfosuccinate esters and/or salts thereof.

In one embodiment, the composition of the present invention further comprises an amphoteric surfactant. Suitable amphoteric surfactants include those surfactants broadly described as derivatives of aliphatic secondary and tertiary amines in which the aliphatic radical can be straight or branched chain and wherein one of the aliphatic substituents contains from about 8 to about 18 carbon atoms and one contains an anionic water solubilizing group such as carboxyl, sulfonate, sulfate, phosphate, or phosphonate. In one embodiment, the amphoteric surfactant comprises at least one compound selected from cocoamphoacetate, cocoamphodiacetate, lauroamphoacetate, and lauroamphodiacetate.

Suitable zwitterionic surfactants include, for example, those surfactants broadly described as derivatives of aliphatic quaternary ammonium, phosphonium, and sulfonium compounds, in which the aliphatic radicals can be straight or branched chain, and wherein one of the aliphatic substituents contains from about 8 to about 18 carbon atoms and one contains an anionic group such as carboxyl, sulfonate, sulfate, phosphate or phosphonate. Specific examples of suitable Zwitterionic surfactants include alkyl betaines, such as cocodimethyl carboxymethyl betaine, lauryl dimethyl carboxymethyl betaine, lauryl dimethyl alpha-carboxy-ethyl betaine, cetyl dimethyl carboxymethyl betaine, lauryl bis-(2-hydroxy-ethyl)carboxy methyl betaine, stearyl bis-(2-hydroxy-propyl)carboxymethyl betaine, oleyl dimethyl gamma-carboxypropyl betaine, and lauryl bis-(2-hydroxypropyl)alpha-carboxyethyl betaine, alkyl amidopropyl betaines, and alkyl sultaines, such as cocodimethyl sulfopropyl betaine, stearyldimethyl sulfopropyl betaine, lauryl dimethyl sulfoethyl betaine, lauryl bis-(2-hydroxy-ethyl)sulfopropyl betaine, and alkylamidopropylhydroxy sultaines.

In one embodiment, the water conditioning component as described herein comprises (i) water and (ii) choline chloride, potassium citrate, citric acid, polyacrylate, ethylenediaminetetraacetic acid (EDTA), dipotassium hydrogenphosphate (K2HPO4), potassium dihydrogenphosphate (KH2PO4), or a combination thereof. The water condition component, in another embodiment, can further include a pH adjusting component (e.g., NaOH) as well as other components. In one embodiment, the water conditioning component further comprises a non-surfactant salt.

The water-soluble non-surfactant salt comprises a cationic component and an anionic component. Suitable cations may be monovalent or multivalent, may be organic or inorganic, and include, for example, sodium, potassium, lithium, calcium, magnesium, cesium, and lithium cations, as well as mono-, di- tri- or quaternary ammonium or pyridinium cation. Suitable anions may be a monovalent or multivalent, may be organic or inorganic, and include, for example, chloride, sulfate, nitrate, nitrite, carbonate, citrate, cyanate acetate, benzoate, tartarate, oxalate, carboxylate, phosphate, and phosphonate anions. Suitable water-soluble non-surfactant salts include, for example, non-surfactant salts of multivalent anions with monovalent cations, such as potassium pyrophosphate, potassium tripolyphosphate, and sodium citrate, non-surfactant salts of multivalent cations with monovalent anions, such as calcium chloride, calcium bromide, zinc halides, barium chloride, and calcium nitrate, and non-surfactant salts of monovalent cations with monovalent anions, such as sodium chloride, potassium chloride, potassium iodide, sodium bromide, ammonium bromide, ammonium sulfate, alkali metal nitrates, and ammonium nitrates.

In one embodiment, the composition of the present invention does not contain any cationic surfactant, anionic surfactant, amphoteric surfactant, zwitterionic surfactant that is a water-soluble salt.

In one embodiment, the composition of the present invention comprises a cationic surfactant, anionic surfactant, amphoteric surfactant, or zwitterionic surfactant, such as, for example, sodium lauryl sulfate, that is a water-soluble salt. The amount of surfactant that is a water-soluble salt is to be included in the total amount of water-soluble salt for purposes of determining the total amount of water-soluble salt component of the composition of the present invention.

As discussed, below, in one embodiment, the composition is a concentrated, dilutable form of an end use composition and further comprises one or more active ingredients, such as, for example, a personal care benefit agent, a pesticidal active ingredient, or a pharmaceutical active ingredient, appropriate to the intended end use. Such active ingredients may be water-soluble non-surfactant salts. The amount of active ingredient that is a water-soluble non-surfactant salt is to be included in the total amount of water-soluble for purposes of determining the total amount of water-soluble salt component of the composition of the present invention.

In one embodiment, the composition of the present invention comprises a water-soluble salt or a glycol, glycol derivative, a glycerol or glycerol derivative in an amount that is effective, either alone or in combination with one or more other water conditioning components, to prevent or to at least inhibit hydration of the polysaccharide, typically in an amount, based on 100 pbw of the composition and including the amount of any water-soluble non-surfactant salt, the amount of any of the surfactant component of the composition of the present invention that is a water-soluble salt and the amount of any of the active ingredient component of the composition of the present invention that is a water-soluble salt, of from greater than 0 pbw, more typically, from about 2 pbw and even more typically, from about 5 pbw, to about 70 pbw, more typically to about 65 pbw and even more typically, to about 60 pbw, of water-soluble salt.

In one embodiment, the composition of the present invention comprises, based on 100 pbw of the composition and including the amount of any water-soluble non-surfactant salt, the amount of any of the surfactant component of the composition of the present invention that is a water-soluble and the amount of any active ingredient component of the composition of the present invention that is a water-soluble salt, from greater than 0 to about 70 pbw, more typically, from about 2 to about 65 pbw and even more typically, from about 5 to about 60 pbw, of water-soluble salt.

In one embodiment, the composition of the present invention comprises a water dispersible organic solvent, in an amount that is effective, either alone or in combination with one or more other hydration inhibiting components, to prevent or to at least inhibit hydration of the polysaccharide, typically in an amount, based on 100 pbw of the composition, of from greater than 0 pbw, more typically from about 2 pbw, and even more typically, from about 5 pbw to about 40 pbw, more typically to about 30 pbw, and even more typically to about 25 pbw, of water dispersible organic solvent. In one embodiment, the organic solvent is glycol, a glycol derivative, a glycerol or a glycerol derivative is polyethylene glycol or polypropylene glycol, glycol ethers or a combination thereof. The water dispersible organic solvent can be combined with water, in other embodiments.

In another embodiment, the composition of the present invention comprises an effective amount at least one surfactant that is effective, either alone or in combination with one or more other hydration inhibiting components, to prevent or to at least inhibit hydration of the polysaccharide. The incomplete hydration can be achieved by several means (1) using dissolved salts in the liquid (2) solvents (either by themselves, or mixed with water as water/water miscible solvents or water/water immiscible solvents) and (3) surfactants with water. Mixture of surfactants with water can make the polysaccharide(s) insoluble, i.e., unhydrated, and flowable.

In one embodiment, the composition of the present invention comprises, based on 100 pbw of the composition, from greater than 0 to about 40 pbw, more typically from about 2 to about 30 pbw, and even more typically, from about 5 to about 25 pbw, of water dispersible organic solvent.

The composition of the present invention is typically made by mixing the components of the composition together.

In one embodiment, wherein the liquid medium is an aqueous medium that comprises water or water and a water miscible organic liquid, the composition is typically made by:

mixing the water conditioning component as described herein with the aqueous liquid medium, and

mixing the drift control component with the mixture of aqueous liquid medium, and water conditioning component.

In one embodiment, wherein the liquid medium is an aqueous medium that comprises water or water and a water miscible organic liquid, the composition is typically made by:

mixing the water conditioning component as described herein with the aqueous liquid medium,

mixing the water-soluble polymer with the mixture of aqueous liquid medium, and water conditioning component, and

mixing the suspending agent with the mixture of the aqueous liquid medium, the water conditioning component and the water-soluble polymer. This manner of addition avoids hydration of the water-soluble polymer and avoids the risk formation of an intermediate composition having an intractably high viscosity.

In another embodiment, wherein the liquid medium is an aqueous medium comprising water and a water immiscible organic liquid, the composition is typically made by:

mixing, optionally, all or a portion of the surfactant, and optionally, a suspending agent, with the water,

mixing the water-soluble polymer, optionally all or a portion of the surfactant, and optionally, a suspending agent, with the water immiscible organic liquid, and

combining the water-based mixture and the water immiscible organic liquid-based mixture to form the composition. The surfactant may be added to either the water mixture or the water immiscible organic liquid mixture, or a portion of the emulsifier may be added to each of the mixtures. If the optional suspending agent is used, all of the suspending agent may all be added to the water, all of the suspending agent may be added to the water immiscible organic liquid, or a first portion of the suspending agent may be added to the water and a second portion of the suspending agent added to the water immiscible organic liquid. The water conditioning component may be used in addition to the water immiscible organic liquid may be added to either the water or the water immiscible organic liquid. This manner of addition avoids hydration of the water-soluble polymer and avoids the risk formation of an intermediate composition having an intractably high viscosity.

In another embodiment, wherein the liquid medium is a non aqueous liquid medium, more typically a water immiscible organic liquid, the pesticide, water-soluble polymer, optional suspending agent and water conditioning component are typically added to the non-aqueous liquid medium and mixed to form the composition.

In one embodiment, the composition of the present invention exhibits dilution thickening behavior, that is, as the composition of the present invention is diluted with water, the viscosity of the viscosity of the composition initially increases with increasing dilution, reaches a maximum value and then decreases with further dilution. The increasing viscosity with increasing dilution corresponds to an increasing concentration of dissolved water-soluble polysaccharide as the concentration of the surfactant and or salt component of the composition decreases with increasing dilution.

In one embodiment, the composition of the present invention is useful as a pumpable liquid source of polysaccharide with a high polysaccharide content for formulating aqueous end use compositions, in particular agricultural pesticide compositions.

In one embodiment, the composition of the present invention is an agricultural adjuvant composition that stable, has a low viscosity, is easily transportable, is pourable and pumpable under field conditions, and is dilutable with water under agricultural field conditions.

In one embodiment, the composition of the present invention is mixed with a pesticide active ingredient and, optionally other adjuvant ingredients, and water to form a dilute pesticide composition for spray application to target pests.

In one embodiment, the composition is a concentrated, dilutable form of an end use composition and further comprises one or more active ingredients, such as, for example, a pesticidal active ingredient or a pharmaceutical active ingredient, appropriate to the intended end use. In one embodiment, the concentrate is diluted to form an end use composition, the end use composition is contacted with a target substrate, such as plant foliage, and the water-soluble polymer component of the concentrate enhances delivery of the active ingredient onto the substrate.

In one embodiment, the composition of the present invention is prepared on an as needed basis and is sufficiently stable, that is, a quiescent sample of the composition shows no evidence, by visual inspection, of gravity driven separation, such as, separation into layers and/or precipitation of components, such as, for example, separation of incompletely hydrated water-soluble polymer from the liquid medium, within the anticipated time period. The time period, for example, can be one hour, more typically two hours, between preparation and use.

In one embodiment, the composition of the present invention exhibits good storage stability and a quiescent sample of the composition shows no evidence, by visual inspection, of gravity driven separation within a given time, such as, for example, one week, more typically, one month, even more typically 3 months, under given storage conditions, such as, for example, at room temperature. In one embodiment,

In one embodiment, the composition of the present invention exhibits good storage stability and a quiescent sample of the composition shows no evidence, by visual inspection, of gravity driven separation within a given time, such as, for example, 24 hours, more typically, four days, even more typically, one week, under accelerated aging conditions at an elevated storage temperature of up to, for example, 54° C., more typically, 45° C.

### Experiments

A typical formulation is shown below in Table 1. The components of the water conditioner are as follows: DI water, tripotassium citrate monohydrate, choline chloride, citric acid solution. Several different rheology modifiers suspending aids were used and the physical properties such as viscosity, separation and flowability were measured after aging at different temperatures and time. The parameters that were varied for the experiments are shown in Table 2.

TABLE 1
Formulation

| Water | to make 100% |
|---|---|
| Water conditioner | 60% |
| Silicone based antifoam | 0.10% |
| suspending aid 1 | varied |
| suspending aid 2 | varied |
| suspending aid 3 | varied |
| PEG | 18% |
| hydroxypropyl guar (HP Guar) | 4% |
| Alcohol ethoxylate surfactant | 3% |
| Benzisothiozolinone (biocide) | 0% |

The procedure to make the formulation is as follows:

Take the polyethylene glycol in a blender. While mixing, add the suspending aids. Then add water and the water conditioner. Then add the antifoam. Then, add the clay and allow sufficient time to mix to obtain a uniform solution. Then, while mixing, slowly add HP Guar, a guar derivative, so that it mixes uniformly without forming lumps. Then, add the alcohol ethoxylate surfactant and finally the biocide. Continue mixing, to make a uniform solution without any lumps.

Transfer the sample to different bottles and age them in preheated ovens at different temperatures. Remove the samples at select time intervals, allow them to cool/heat to room temperature (˜20 C). Measure the physical properties such as viscosity, separation and flowability. The viscosity is measured using a Brookfield viscometer and LV#3 spindle and measured at 30 rpm. The results are shown in Table 3 to 5.

TABLE 2

| Expt # | #1 | #2 | #3 | #4 | #5 | #6 | #7 |
|---|---|---|---|---|---|---|---|
| PEG (%) | 18 | 18 | 18 | 18 | 18 | 18 | 18 |
| suspending aid 1 | 0.05 | 0 | 0.05 | 0.025 | 0.025 | 0 | 0 |
| suspending aid 2 | 0 | 0.1 | 0 | | | 0.2 | 0.3 |
| suspending aid 3 | 0 | 0 | 3 | 3 | 5 | 0 | 0 |
| Alcohol | 3 | 3 | 4.5 | 3 | 3 | 3 | 3 |
| ethoxylate | | | | | | | |
| surfactant(%) | | | | | | | |

TABLE 3
Brookfield viscosity, cP at 30 rpm, LV#3 spindle measured
at room temperatures after aging at different temperature

| | T(C.) | | | | | | |
|---|---|---|---|---|---|---|---|
| | | 54 C., 1 | 45 C., 1 | RT, 1 | 54 C. 2 | 45 C., 2 | RT, 2 |
| | Initial | week | week | week | weeks | weeks | weeks |
| #1 | 300 | 1150 | 1100 | 725 | 1350 | 1300 | 820 |
| #2 | 360 | | | | | | 176 |
| #3 | 880 | 1900 | 1400 | 1100 | 2600 | 1650 | 1065 |
| #4 | 660 | 1350 | 800 | 650 | 2200 | 900 | 660 |
| #5 | 1250 | 4000 | 1400 | 1360 | 4000 | 1800 | 1150 |
| #6 | 660 | | | | >4000 | 1285 | 730 |
| #7 | 1150 | | | | >4000 | 1800 | 1250 |

TABLE 4
Separation (%)

| | T(C.) | | | | | | |
|---|---|---|---|---|---|---|---|
| | | 54 C., 1 | 45 C., 1 | RT, 1 | 54 C. 2 | 45 C., 2 | RT, 2 |
| | Initial | week | week | week | weeks | weeks | weeks |
| #1 | — | 0 | 0 | 0 | 9 | 10 | 0 |
| #2 | — | 30 | 30 | 20 | 35 | 28 | 40 |
| #3 | — | 0 | 0 | 0 | 2 | 1 | 1 |
| #4 | — | 0 | 5 | 3 | 0 | 5 | 6 |
| #5 | — | 0 | 1 | 1 | 0 | 1 | 2 |
| #6 | — | | | | 30 | 0 | 0 |
| #7 | — | | | | 30 | 0 | 0 |

TABLE 5
Flowability

| | | 54 C., 1 | 45 C., 1 | RT, 1 | 54 C. 2 | 45 C., 2 | RT, 2 |
|---|---|---|---|---|---|---|---|
| | Initial | week | week | week | weeks | weeks | weeks |
| #1 | Flowable | flowable | flow | flowable | flowable | flowable | flowable |
| #2 | Flowable | flowable | flowable | flowable | flowable | flowable | flowable |
| #3 | Flowable | flowable | flowable | flowable | flowable | flowable | flowable |
| #4 | Flowable | flowable | flowable | flowable | flowable | flowable | flowable |
| #5 | Flowable | diff to | diff to | flowable | diff to | diff to | flowable |
| | | flow | flow | | flow | flow | |
| #6 | Flowable | | | | Diff to | flowable | Flowable |
| | | | | | flow | | |
| #7 | flowable | | | | Diff to | flowable | flowable |
| | | | | | flow | | |
| #8 | | | | | | | |
| #9 | | | | | | | |
| #10 | | | | | | | |
| #11 | | | | | | | |

Additional experiments were performed similarly with other types of guar derivatives and the results are shown below

TABLE 6

| Expt # | #8 | #9 | #10 |
|---|---|---|---|
| Water | to make | To make | To make |
| | 100% | 100% | 100% |
| Water conditioner | 60% | 60% | 60% |
| Silicone based antifoam | 0.10% | 0.1% | 0.1% |
| suspending aid 1 | 0.05% | 0.05% | 0.03% |
| suspending aid 3 | 2% | 2% | 0.5% |
| PEG | 18% | 18% | 22% |
| Guar Gum | 4% | | |
| Carboxymethyl guar | | 4% | |
| Carboxymethyl hydroxypropyl guar | | | 4% |
| Alcohol ethoxylate surfactant | 2% | 2% | 2% |
| Benzisothiozolinone (biocide) | 0.1% | 0.1% | 0.1% |

TABLE 7
Brookfield viscosity, cP at 30 rpm, LV#3 spindle measured
at room temperatures after aging at different temperature

| | T(C.) | | | | | | |
|---|---|---|---|---|---|---|---|
| | | 54 C., 1 | 45 C., 1 | RT, 1 | 54 C. 2 | 45 C., 2 | RT, 2 |
| | Initial | week | week | week | weeks | weeks | weeks |
| #8 | 420 | 736 | | | 756 | 560 | 436 |
| #9 | 460 | 700 | | | 770 | 572 | 440 |
| #10 | 1008 | 1136 | | | 1248 | 1232 | 1096 |

TABLE 8
Separation (%)

| | T(C.) | | | | | | |
|---|---|---|---|---|---|---|---|
| | | 54 C., 1 | 45 C., 1 | RT, 1 | 54 C. 2 | 45 C., 2 | RT, 2 |
| | Initial | week | week | week | weeks | weeks | weeks |
| #8 | — | 1 | | | 2 | 2 | 6 |
| #9 | — | 1 | | | 2 | 2 | 1 |
| #10 | — | 0 | 0 | 0 | 0 | 0 | 0 |

TABLE 9
Flowability

| | | 54 C., 1 | 45 C., 1 | RT, 1 | 54 C. 2 | 45 C., 2 | RT, 2 |
|---|---|---|---|---|---|---|---|
| | Initial | week | week | week | weeks | weeks | weeks |
| #8 | Flowable | flowable | | | flowable | flowable | flowable |
| #9 | Flowable | flowable | | | flowable | flowable | flowable |
| #10 | Flowable | Flowable | Flowable | flowable | flowable | flowable | flowable |

What is claimed is:

1. An agricultural composition comprising:
a drift control component comprising:
an incompletely hydrated water-soluble polymer suspended in a liquid medium,
a suspending agent in an amount effective to impart shear thinning properties to the composition,
optionally, a glycol, a glycol derivative, a glycerol, or a glycerol derivative,
a surfactant; and
a water conditioning component comprising: choline chloride, potassium citrate, citric acid, polyacrylate, ethylenediaminetetraacetic acid, dipotassium hydrogenphosphate (K₂HPO₄), potassium dihydrogenphosphate (KH₂PO₄), any salt thereof, or a combination thereof.

2. The composition of claim 1 wherein the agricultural composition is flowable and exhibits a viscosity of less than 10 Pa·s at a shear rate of greater than or equal to 10 s⁻¹.

3. The composition of claim 1 wherein the agricultural composition is flowable and exhibits a viscosity of less than 1 Pa·s at a shear rate of greater than or equal to 10 s⁻¹.

4. The composition of claim 1 wherein the water conditioning component comprises choline chloride.

5. The composition of claim 1 wherein the suspending agent is selected from fumed silica, precipitated silica, inorganic colloidal or colloid-forming particles, rheology modifier polymers, or mixtures thereof.

6. The composition of claim 1 wherein the water-soluble polymer is a guar or a guar derivative.

7. The composition of claim 1 wherein the water-soluble polymer is guar, carboxymethyl guar, carboxymethylhydroxypropyl guar, cationic hydroxypropyl guar, hydroxyethyl guar, hydroxypropyl guar, hydroxybutyl guar, carboxylpropyl guar, carboxybutyl guar, xanthan gum, and mixtures thereof.

8. The composition of claim 1 wherein the glycol, the glycol derivative, the glycerol or the glycerol derivative is present and comprises polyethylene glycol.

9. The composition of claim 1, further comprising a pesticide active ingredient, wherein the water-soluble polymer enhances delivery of the pesticide active ingredient from the liquid medium to a target substrate.

10. The composition of claim 1, wherein the liquid medium is an aqueous liquid medium that comprises water or water and a water immiscible organic liquid, and wherein the composition is in the form of an emulsion, a microemulsion, or a suspoemulsion.

11. The composition of claim 1, wherein:
the water-soluble polymer is selected from polyacrylamide polymers, non-derivatized guar polymers, derivatized guar polymers, and mixtures thereof, and
the suspending agent is selected from fumed silicas, precipitated silicas, inorganic colloidal or colloid-forming particles, rheology modifier polymers, water-soluble polysaccharide polymers other than the non-derivatized or derivatized guar polymer, and mixtures thereof.

12. The composition of claim 1 wherein the surfactant is selected from alkanalkanolamides, ethoxylated alkanolamides, ethylene bisamides, alkyl betaines, alkyl amidopropyl betaines, alkyl sultaines, fatty acid esters, glycerol esters, ethoxylated fatty acid esters, sorbitan esters, ethoxylated sorbitans, alkylphenol ethoxylates, alcohol ethoxylates, tristyrylphenol ethoxylates, mercaptan ethoxylates; ethylene oxide/propylene oxide block copolymers, chlorine capped ethoxylates, tetra-functional block copolymers, lauramine oxide, cocamine oxide, stearamine oxide, stearamidopropylamine oxide, palmitamidopropylamine oxide, decylamine oxide, mono ester sulfosuccinates, diester sulfosuccinates, fatty alcohols, alkoxylated alcohols, or any mixtures thereof.

13. The composition of claim 1 wherein the surfactant is a linear or branched alcohol ethoxylate.

14. The composition of claim 1 wherein the surfactant is a mono ester sulfosuccinate or a diester sulfosuccinate.

15. The composition of claim 1 wherein the surfactant is sodium dioctyl sulfosuccinate, sodium bistridecyl sulfosuccinate, sodium dihexyl sulfosuccinate, or sodium diisobutyl sulfosuccinate.

16. The composition of claim 1 wherein the surfactant imparts an improved property to the composition, wherein the improved property is one or more of the following: dispersability, wetting, biological efficacy improvement, as a sticker, or as a spreader.

17. The composition of claim 1 wherein the composition comprises, based on 100 parts by weight of the composition, at least 2 parts by weight of an incompletely hydrated water-soluble polymer suspended in a liquid medium.

18. The composition of claim 1 wherein the composition comprises, based on 100 parts by weight of the composition, at least 3 parts by weight of an incompletely hydrated water-soluble polymer suspended in a liquid medium.

19. The composition of claim 1 wherein the composition comprises, based on 100 parts by weight of the composition, at least 4 parts by weight of an incompletely hydrated water-soluble polymer suspended in a liquid medium.

20. The composition of claim 1 wherein the suspending agent is xanthan gum, rheozan, diutan, welan gum, succinoglycan, scleroglucan or any combination thereof.

21. The composition of claim 1 wherein the suspending agent is a mixture of at least two of the following: fumed silica, precipitated silica, inorganic colloidal particles or colloid-forming particles.

22. The composition of claim 1 wherein the suspending agent is a hydrophobic associative rheology modifier.

23. The composition of claim 1 wherein the composition is free or substantially free of ammonium-containing compounds.

24. A method for making an agricultural composition that comprises a mixture of an aqueous liquid medium, an incompletely hydrated water-soluble polymer dispersed in the aqueous liquid medium, and a water conditioning component, the steps comprising:
contacting the water conditioning component with the aqueous liquid medium, wherein the water conditioning component comprises choline chloride, potassium citrate, polyacrylate, ethylenediaminetetraacetic acid, citric acid, a polycarboxylate, dipotassium hydrogenphosphate (K₂HPO₄), potassium dihydrogenphosphate (KH₂PO₄), any salts thereof, or a combination thereof; and
contacting a drift control component with the mixture of aqueous liquid and the water conditioning component, wherein the drift control component comprises:
an incompletely hydrated water-soluble polymer,
a suspending agent in an amount effective to impart shear thinning properties to the composition,
the glycol, the glycol derivative, the glycerol or the glycerol derivative, and
a surfactant.

25. The method of claim 24 further comprising contacting an agricultural pesticide compound to the composition.

26. The method of claim 24 wherein the composition is free or substantially free of ammonium-containing compounds.
